(19) United States
(12) Patent Application Publication
(10) Pub. No.: US 2009/0116452 A1
(43) Pub. Date: May 7, 2009

(54) APPARATUS AND METHOD FOR A MOBILE NODE ROAMING IN AN IPv6 NETWORK

(75) Inventor: Hongguang Guan, Shenzhen (CN)

Correspondence Address: Leydig, Voit & Mayer, Ltd;(for Huawei Technologies Co., Ltd), Two Prudential Plaza Suite 4900, 180 North Stetson Avenue, Chicago, IL, 60601, US

(73) Assignee: HUAWEI TECHNOLOGIES CO., LTD., Shenzhen (CN)

(21) Appl. No.: 12/349,105

(22) Filed: Jan. 6, 2009

Related U.S. Application Data
(63) Continuation of application No. PCT/CN2007/070367, filed on Jul. 26, 2007.

(30) Foreign Application Priority Data
Jul. 28, 2006 (CN) 200610099554.7

(51) Int. Cl. H04W 36/00

(52) U.S. Cl. 370/331

(57) ABSTRACT

The present invention discloses an apparatus and method for a mobile node roaming in an Internet Protocol version 6 (IPv6) network. The apparatus includes a foreign home agent (FHA). The method includes: when a mobile node (MN) moves from an Internet Protocol version 4 (IPv4) network to an IPv6 network, a FHA exchanges messages with the MN and the IPv4 home agent (HAv4) of the MN to register tunnels at the IPv6 network interface and the IPv4 network interface. The method further includes: the MN sends a Binding Update (BU) message that carries an IPv4 registration option of the MN, when the MN moves from the IPv4 network to the IPv6 network. With the present invention, the routing scheme for a dual-stack MN to roam from an IPv6 network to an IPv4 network is implemented.

### CROSS-REFERENCE TO RELATED APPLICATIONS

This application is a continuation of International Patent Application No. PCT/CN2007/070367, filed Jul. 26, 2007, which claims priority to Chinese Patent Application No. 200610099554.7, filed Jul. 28, 2006, both of which are hereby incorporated by reference in their entirety.

### FIELD OF THE INVENTION

The present invention relates to network communication technologies, and, in particular, to an apparatus and a method for a mobile node roaming in an Internet Protocol version 6 (IPv6) network.

### BACKGROUND OF THE INVENTION

In the existing Transmission Control Protocol (TCP)/Internet Protocol (IP) framework, the IP address of a mobile node (MN) represents the location of the MN. When a communication node (CN) sends data packets to the MN, the route is determined, according to the network indicated by the IP address of the MN. When the MN roams from its home network to a foreign network, the data packets sent by the CN to the MN will still be routed to the home network of the MN. But because the MN is not located in the home network at the time, the packets will be discarded in the home network of the MN, and the communication between the CN and the MN will be interrupted.

With the development of mobile communication technologies, it is required that a future network should be IP-based and that, when the MN roams or roves to a foreign network, the ongoing communication should be held continuous without interruption. The traditional TCP/IP does not satisfy the above requirement of mobile communications. The Internet Engineering Task Force (IETF), therefore, has proposed Mobile IP version 4 (MIPv4) and Mobile IP version 6 (MIPv6).

MIPv4 and MIPv6 provide respective methods for a MN to communicate by means of its home IP address, when the MN roams in an IPv4 or IPv6 network.

MIPv4 allows a MIPv4-enabled node to move in a MIPv4 network and hold an ongoing connection during a movement. The specific MIPv4 procedure is as follows:

Triangle routing is adopted. When a MN is on its home link, the MN follows the normal IPv4 procedure. When the MN moves from the home link to a foreign link, the MN must first obtain a care of address (CoA) on the foreign link and register the CoA with the home agent (HA).

A CN can see only the home address (HoA) of the MN and does not know that the MN has moved. This means, for the CN, the movement of the MN is transparent. The HoA is an address that is permanently assigned to the MN on the home link. Therefore, the CN will still send a packet destined to the MN directly to the HoA of the MN. When the packet is routed to the HA of the MN, the HA sends the packet to the CoA of the MN registered with the HA through a tunnel. Data sent by the MN to the CN is sent to the CN directly. In the above procedure, the MN must support MIPv4.

MIPv6 allows a MIPv6-enabled node to move and maintain the continuity of an ongoing communication during the movement. Like the above MIPv4 procedure, when the MN moves from the home network to a foreign network, the MN first obtains a CoA in the foreign network and registers the CoA with the HA via a Binding Update (BU) message. When the HA receives the BU message from the MN, the HA returns a Binding acknowledgement and generates a cache entry on the HA. In an IPv6 network, a MN may also adopt a route optimization method.

MIPv4 and MIPv6 have enabled the movement of a MN in their respective field. However, with the deployment of MIPv4 and MIPv6 solutions and the application of MIP, it is common that a MN will roam between the two types of networks. This results in another problem. If a MN moves from a MIPv4 network to a MIPv6 network, or from a MIPv6 network to a MIPv4 network, how can the previous connectivity be maintained?

In a prior art, a method for implementing roaming of a MN between IPv6 and IPv4 networks is: the IETF proposes a dual-stack MIP (DSMIP) solution, which requires that both the HA of the MN and the MN support dual-stack and have both IPv4 and IPv6 addresses. The tunnel broker technology is applied in DSMIP to solve the roaming and traversal of a MN in an IPv4 network.

However, the inventor of the present invention finds that the method in the prior art is subject to the following weakness: the HA must have an IPv4 address and must support dual-stack, which will occupy the precious IPv4 address resources. The tunnel broker technology may introduce many entries to the IPv6 routing table so that the IPv6 routing table is over-large, which is contrary to the initial intent of IPv6 design.

### SUMMARY OF THE INVENTION

The present invention intends to provide an apparatus and a method for a mobile node roaming in an IPv6 network, so that a dual-stack mobile node can roam from an IPv4 network to an IPv6 network.

The purpose of embodiments of the invention is realized through the following technical scheme:

An apparatus for a mobile node roaming in an IPv6 network includes: a foreign home agent (FHA), which has both an IPv6 address and an IPv4 address and registers a tunnel, respectively, in an IPv6 network interface and an IPv4 network interface, when a mobile node (MN) moves from an IPv4 network to an IPv6 network.

A method for a mobile node roaming in an IPv6 network includes: sending, by a mobile node (MN), a Binding Update (BU) message that carries an IPv4 registration option of the MN, when the MN moves from an IPv4 network to an IPv6 network.

In the technical scheme provided by embodiments of the present invention, a FHA is set to establish tunnels between the FHA and the MN and between the FHA and the IPv4 home agent (HAv4) of the MN, so that a dual-stack MN can roam from an IPv4 network to an IPv6 network. Compared with prior arts, this technical scheme has the following advantages:

The HA does not need to support dual-stack and the present invention only extends the current protocol with a few changes to the current protocol; and

Embodiments of the present invention are easy to implement, without introducing many entries to the IPv6 routing table and resulting in an over-large IPv6 routing table.

### BRIEF DESCRIPTION OF THE DRAWINGS

FIG. 1 is a schematic diagram showing the structure of an apparatus for a mobile node roaming in an IPv6 network, according to an embodiment of the present invention;

FIG. 2 shows a procedure for a mobile node roaming in an IPv6 network, according to an embodiment of the present invention;

FIG. 3 shows the format of the registration request extension option, according to an embodiment of the present invention;

FIG. 4 shows the format of the registration acknowledgement extension option, according to an embodiment of the present invention;

FIG. 5 shows a procedure where PEBU and PEBack, registration message, and registration reply are exchanged, according to an embodiment of the present invention;

FIG. 6 shows the format of the binding update extension option, according to an embodiment of the present invention;

FIG. 7 shows the format of the binding acknowledgement extension option, according to an embodiment of the present invention; and

FIG. 8 shows a procedure where messages are exchanged between FHA and MN, when the MN moves from an IPv6 network to an IPv4 network.

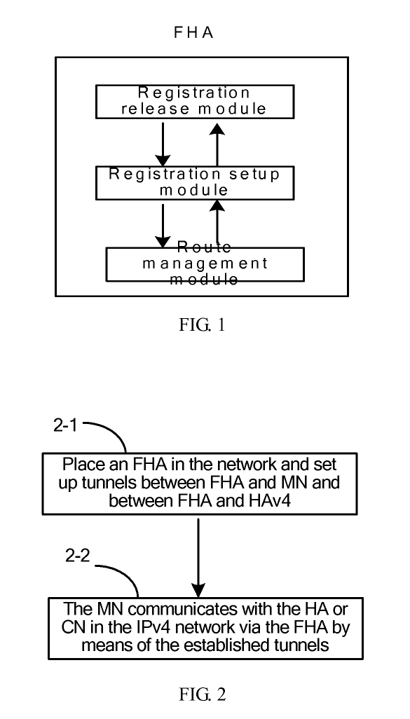

### DETAILED DESCRIPTION OF THE EMBODIMENTS

Embodiments of the invention provide an apparatus and a method for a mobile node roaming in an IPv6 network. In embodiments of the invention, a foreign home agent (FHA) is placed at the boundary of an IPv6 network and an IPv4 network, or in a hybrid network, to establish tunnels between the FHA and a mobile node (MN), and between the FHA and the IPv4 home agent (HAv4) of the MN. When the MN roams from the IPv4 network to the IPv6 network, the MN communicates with an IPv4 communication node (CNv4) via the FHA.

The following describes the present invention in detail with reference to the accompanying drawings. An apparatus for a mobile node roaming in an IPv6 network includes a FHA, with its structure shown in FIG. 1.

The FHA supports MIP4 and MIP6 simultaneously, that is, supports dual-stack, and has both an IPv6 address and an IPv4 address. The FHA is placed at the boundary of an IPv6 network and an IPv4 network or in a hybrid network of IPv6 and IPv4. When a MN moves from an IPv4 network to an IPv6 network, tunnels are registered, respectively, at the IPv6 network interface and the IPv4 network interface. This means, a tunnel between FHA and MN is registered in the IPv6 network and a tunnel between FHA and HAv4 is registered in the IPv4 network. The FHA transfers data packets between the MN and the CNv4 via the two tunnels.

In response to the two tunnels, the FHA needs to generate and store two cache entries. One cache entry corresponds to (FHoAv6, CoA) in the IPv6 network. The other cache entry corresponds to (HAA, FHoAv4) in the IPv4 network. For the purpose of associating the two tunnels, the FHA also needs to generate and store a map (FHoAv4, FHoAv6). The FHoAv6 is the IPv6 foreign home address that the MN obtained from the FHA. The CoA is the care of address of the MN in the IPv6 network. The FHoAv4 is the IPv4 foreign home address that the MN obtained from the FHA. The HAA is the home agent address of the MN in the IPv4 network.

The FHA includes a registration setup module, a registration release module and a route management module.

The registration setup module is adapted to register a tunnel between FHA and MN at the IPv6 network interface and generate and store a corresponding cache entry (FHoAv6, CoA), when the MN moves from an IPv4 network to an IPv6 network; register a tunnel between FHA and HAv4 at the IPv4 network interface and generate and store a corresponding cache entry (HAA, FHoAv4); and generate and store a map (FHoAv4, FHoAv6).

The registration release module is adapted to release the FHA-MN tunnel registered at the IPv6 network interface and delete the stored corresponding cache entry (FHoAv6, CoA) and the entry corresponding to the FHA in the map (FHoAv4, FHoAv6), when the MN returns from the IPv6 network to the IPv4 network.

The route management module is adapted to transfer data packets between MN and HAv4 via the FHA-MN tunnel and FHA-HAv4 tunnel registered by the registration setup module, according to the map information stored by the registration setup module, when the MN moves from the IPv4 network to the IPv6 network.

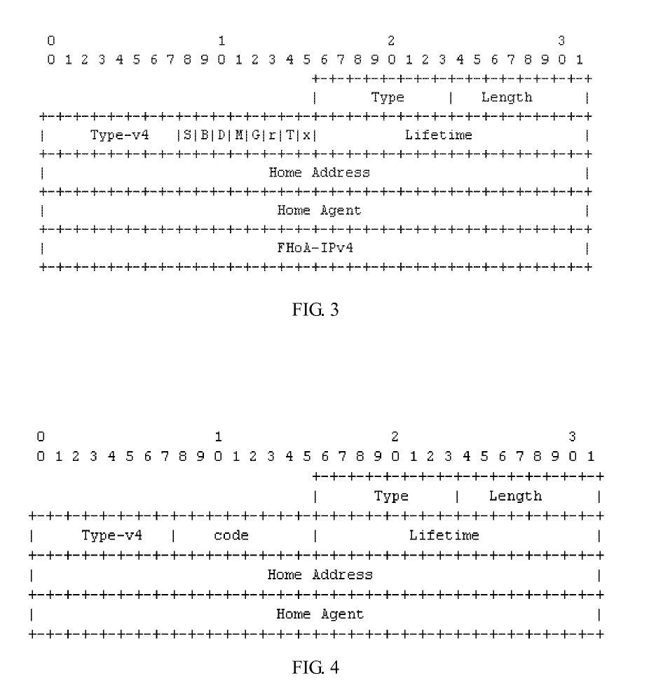

As shown in FIG. 3, a procedure for a mobile node roaming in an IPv6 network, according to an embodiment of the invention, includes the following steps:

Step 2-1: Placing a FHA in the network and setting up tunnels between FHA and MN and between FHA and HAv4.

In an embodiment of the present invention, a FHA server needs to be placed at the boundary of an IPv6 network and an IPv4 network or in a hybrid network of IPv6 and IPv4. The FHA server supports MIPv4 and MIPv6 simultaneously and has both an IPv4 address and an IPv6 address.

When the MN roams from the IPv4 network to the IPv6 network, the MN obtains a CoA from an access router (AR) in the IPv6 network and sends a Proxy Extension Binding Update (PEBU) message to the FHoA_IPv6 interface of the FHA. Then, a tunnel is set up between the MN and the FHAv6. The source address of the PEBU is the CoA obtained by the MN from the AR and the destination address is FHoAv6. The PEBU carries a registration request extension option and the lifetime value in the registration request extension option must be smaller than or equal to the lifetime value in the PEBU.

The format of the registration request extension option is shown in FIG. 3. The following describes some parameters:

Type: to be determined (TBD);

Length: 16;

FHoA-IPv4: address of the FHA in the IPv4 network;

Type-v4: corresponding to the type in the registration request message (refer to RFC [3344]);

Other parameters: reference can be made to RFC [3344].

When the FHA receives the PEBU message, the FHA generates a registration message (RReq, registration request message), according to the binding update extension option in the PEBU message. The source address of the registration message is FHoAv4 and the destination address is HAA. Meanwhile, the FHA must also generate and store a cache entry (FHoAv6, CoA). Then, the FHA sends the registration message from the IPv4 network interface of the FHA to the HAv4. Then, a tunnel is set up between the HAv4 and the FHAv4. Likewise, the lifetime value in the binding update extension option of the registration message must be smaller than or equal to the lifetime value in the registration message. Afterwards, the FHA must generate and store a map (FHoAv4, FHoAv6) and another cache entry (HAA, FHoAv4).

When the HAv4 receives the registration message sent by the FHA, the HAv4 must generate and store a cache entry (HoA, FHoAv4), or else the HAv4 needs to update the registration cycle, according to the registration message, and then send a registration reply (RRep) to the IPv4 network interface of the FHA.

Upon reception of the registration reply, the FHA sends a Proxy Extension Binding Acknowledgement (PEBack) message on the IPv6 interface of the FHA to the MN. The source address of the PEBack is FHoAv6 and the destination address is the CoA obtained by the MN from the AR. The PEBack must carry a registration acknowledgement extension option, which is obtained according to the registration reply message. The format of the registration acknowledgement extension option is shown in FIG. 4. Some parameters in the registration acknowledgement extension option are as follows: Type: TBD; Length: 12. When the MN receives a PEBack for the first time, the MN must generate and store a cache entry (CoA, FHoAv6).

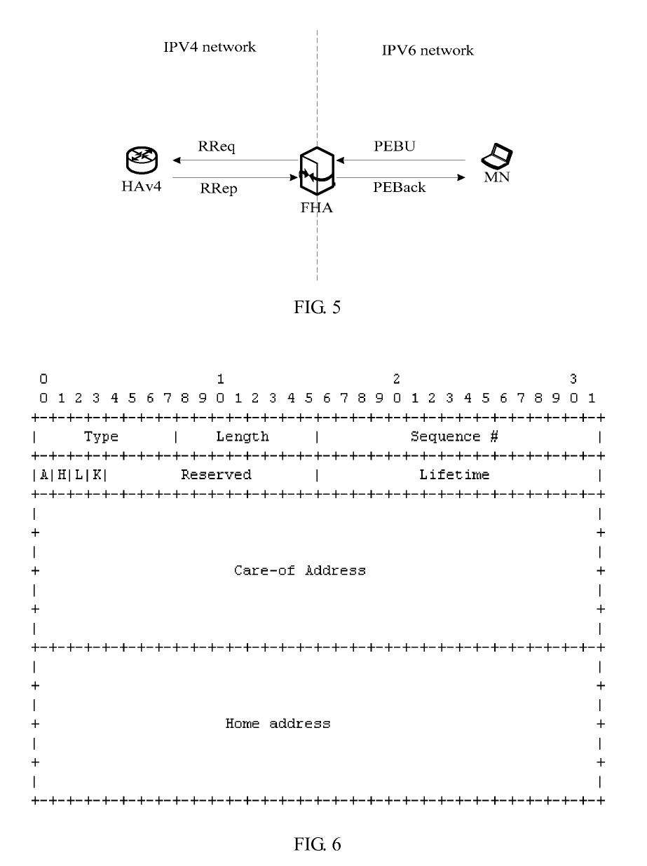

FIG. 5 shows a procedure where PEBU and PEBack, registration message and registration reply messages are exchanged, according to an embodiment of the invention.

When the MN returns from the IPv6 network to the IPv4 network, the MN must send a registration request extension (PERReq, Proxy Extension Registration Request) message to the FHA. The registration request extension message includes a binding update extension option, where value of the parameter lifetime must be 0. The format of the binding update extension option is shown in FIG. 6. Some parameters in the binding update extension option are as follows: Type: TBD; Length: 38.

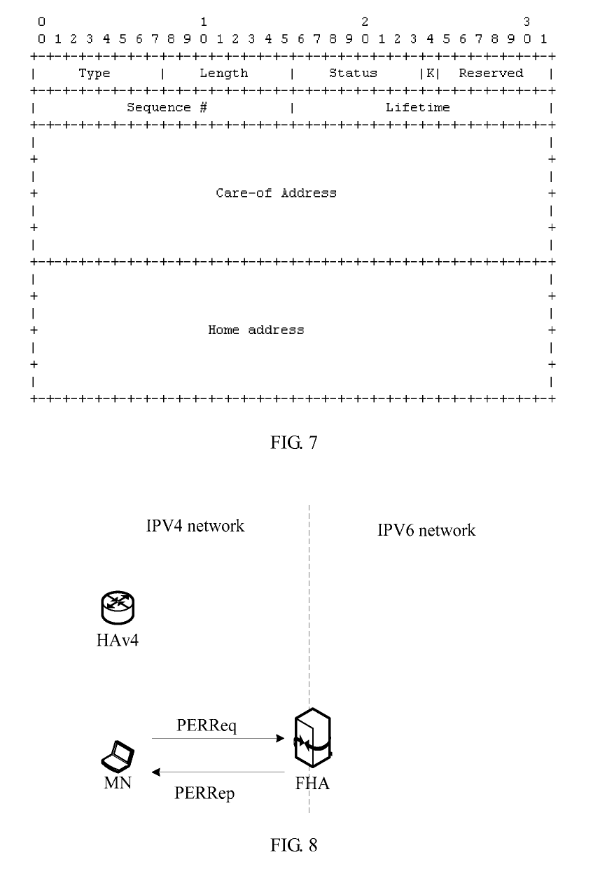

Upon reception of the registration request extension message, the FHA releases the tunnel between the MN and the FHA in the IPv6 network, and must delete the cache entry corresponding to the MN registered in the IPv6 network and the entry corresponding to the FHA in the map (FHoAv4, FHoAv6). Then, the FHA sends a registration reply extension (PERRep, Proxy Extension Registration Reply) message to the MN. The message must include a binding acknowledgment extension option. The format of this extension option is shown in FIG. 7. Some parameters of the binding acknowledgment extension option are as follows: Type: TBD; Length: 38.

A procedure for messages exchange between FHA and MN when the MN returns from the IPv6 network to the IPv4 network is shown in FIG. 8.

Step 2-2: The MN communicates with the HA or CN in the IPv4 network via the FHA, by means of the established tunnels.

When the MN roams to the IPv6 network, the FHA acts as an IPv6 temporary home agent (THAv6) of the MN. The MN and a CNv6 communicate over normal MIPv6. In this case, the THAv6 serves as the home agent of the MN in the IPv6 network. When the MN communicates with a CNv4, the MN sends data packets to the FHA via the established FHA-MN tunnel. The FHA sends the data packets to the HAv4 via the established FHA-HAv4 tunnel. The HAv4 then sends the data packets to the CNv4. Conversely, the CNv4 sends data packets to the HAv4. The HAv4 sends the data packets to the FHA via the established FHA-HAv4 tunnel. The FHA then sends the data packets to the MN via the established FHA-MN tunnel.

When the MN is in the IPv4 network, the MN communicates with a CNv4 over normal MIPv4. When the MN communicates with a CNv6, the MN sends data packets to the HAv4. The HAv4 sends the data packets to the FHA via the established FHA-HAv4 tunnel. The FHA then sends the data packets to the CNv6 via the established FHA-MN tunnel. The above procedure for transferring data packets requires that the FHA establishes a tunnel with each CNv6. Conversely, the CNv6 sends data packets to the FHA via a reverse tunnel. The FHA sends the data packets to the HAv4 via a tunnel. The HAv4 then sends the data packets to the MN.

In the above procedure, the operations requirements of MN, FHA, and HA are as follows:

MN Operations:

In an IPv6 network, when the MN moves from one link to another, or the registration will soon expire, the MN must send a PEBU to the FHA immediately. Value of the parameter lifetime in the registration request extension option in the PEBU must be smaller or equal to the lifetime value in the PEBU.

When the MN receives the PEBack returned by the FHA in response to the PEBU for the first time, the MN must generate a cache entry (CoA, FHoAv6).

When the MN returns from the IPv6 network to the IPv4 network, the MN must send a registration request extension message to the FHA. The registration request extension message includes a binding update extension option, where value of the parameter lifetime must be 0.

FHA Operations:

Upon reception of the PEBU from the MN, the FHA must generate a registration message (RReq, registration request message), according to the registration request extension option in the PEBU. Meanwhile, the FHA must generate a cache entry (FHoAv6, CoA). Then, the FHA must send the generated registration message to the HA via the IPv4 network interface of the FHA. Afterwards, the FHA must generate a map (FHoAv4, FHoAv6) and another cache entry (HAA, FHoAv4).

Upon reception of the registration reply (RRep) of the HA, the FHA must return a PEBack to the MN. The registration acknowledgement extension option in the PEBack is generated, according to the registration reply.

Upon reception of a registration request extension message (PERReq) where the lifetime value in the binding update extension option is 0, the FHA must delete the corresponding cache entry and the corresponding entry in the map (FHoAv4, FHoAv6).

HA Operations:

Upon reception of a registration message (RReq) from the FHA for the first time, the HA must generate a cache entry (HoA, FHoAv4), or else update the registration cycle according to the registration message.

In response to the registration message, the HA must send a registration reply (RRep) to the FHA.

Although the technical scheme of the present invention has been described through exemplary embodiments, the invention is not limited to such embodiments. It is apparent that those skilled in the art can make various modifications and variations to the invention without departing from the spirit and scope of the invention. The invention is intended to cover the modifications and variations provided that they fall in the scope of protection defined by the claims or their equivalents.

What is claimed is:

1. An apparatus for a mobile node (MN) roaming in an Internet Protocol version 6 (IPv6) network, comprising:
a registration setup module adapted to register a tunnel on an IPv6 network interface between the MN and a foreign home agent (FHA) upon a Binding Update (BU) message from the MN, wherein the FHA has been assigned both an IPv6 address and an Internet Protocol version 4 (IPv4) address, when the MN roams from an IPv4 network to the IPv6 network; and
register a tunnel between the FHA and the IPv4 home agent (HAv4) of the MN on the IPv4 network interface.

2. The apparatus of claim 1, wherein the a registration setup module is further adapted to generate and store a map between an IPv6 foreign home address (FHoAV6) obtained by the MN from the FHA and a care of address (CoA) of the MN in the IPv6 network; generate and store a map between an IPv4 foreign home address (FHoAv4) obtained by the MN from the FHA and an address of the HAv4 (HAA); accordingly, the apparatus further comprises:
a route management module, adapted to transfer data packets between the MN and the HAv4 via the tunnels registered by the registration setup module, according to map information stored by the registration setup module.

3. The apparatus of claim 2, wherein the apparatus further comprises:
a registration release module, adapted to release the tunnel between the FHA and the MN registered on the IPv6 network interface by the registration setup module, and delete the stored map between the FHoAv6 obtained by the MN from the FHA and the CoA.

4. The apparatus of claim 1, wherein the apparatus is placed at a boundary of the IPv6 network and the IPv4 network, or a hybrid network of IPv6 and IPv4.

5. A mobile node (MN), comprising:
means for obtaining a care of address (CoA) in the IPv6 network, when the MN roams from its IPv4 home network to the IPv6 network;
means for obtaining an IPv6 foreign home address (FHoAv6) from a foreign home agent (FHA);
means for sending a Proxy Extension Binding Update (PEBU) message to the FHA; wherein the PEBU carries a registration request extension option and the lifetime value in the registration request extension option is smaller than or equal to the lifetime value in the PEBU, the source address of the PEBU is the CoA and the destination address is the FHoAv6; and
means for receiving a Proxy Extension Binding Acknowledgement (PEBack) message from the FHA, wherein the PEBack carries a registration acknowledgement extension option, the source address of the PEBack is the FHoAv6 and the destination address is the CoA.

6. The MN of claim 5, furthering comprising:
means for generating and storing a cache entry (CoA, FHoAv6), when the MN receives a PEBack for the first time.

7. The MN of claim 5, furthering comprising:
means for sending a registration request extension (PERReq) message to the FHA, the PERReq message includes a binding update extension option, wherein value of the lifetime is 0; and
means for receiving a registration reply extension (PERRep) message from the FHA, the PERRep message carries a binding acknowledgment extension option.

8. The MN of claim 5, furthering comprising:
transferring data packets to the FHA via the tunnel between the FHA and the MN, when the MN roams from the IPv4 network to the IPv6 network.

9. A method for a mobile node (MN) roaming in an Internet Protocol version 6 (IPv6) network, wherein, when the MN roams from its IPv4 home network to the IPv6 network, comprising:
receiving, by an foreign home agent (FHA), a Binding Update (BU) message from the MN, wherein the FHA has been assigned both an IPv6 address and an Internet Protocol version 4 (IPv4) address;
registering a tunnel on an IPv6 network interface between the MN and the FHA, according to the BU message; and
registering a tunnel between the FHA and an IPv4 home agent (HAv4) of the MN on the IPv4 network interface, according to the BU message.

10. The method of claim 9, wherein registering the tunnel between the FHA and the IPv4 home agent (HAv4) of the MN is implemented by:
generating a registration message (RReq), by the FHA;
sending the RReq message to the IPv4 home agent (HAv4) of the MN, where the source address is an IPv4 foreign home address (FHoAv4) obtained by the MN from the FHA and the destination address is the home agent address (HAA) of the MN, which carries a binding update extension option comprising registration information of the MN in the IPv4 network, value of lifetime in the binding update extension option carried in the registration message is smaller than or equal to that of lifetime in the registration message; and
setting up the tunnel between the HAv4 and the FHA.

11. The method of claim 10, wherein the Binding Update (BU) message is a Proxy Extension Binding Update (PEBU) message, wherein the source address is a care of address (CoA) and the destination address is an IPv6 foreign home address (FHoAv6) obtained by the MN from the FHA, wherein the PEBU message carries a registration request extension option comprising registration information of the MN in the IPv4 network, and wherein value of lifetime in the registration request extension option carried in the PEBU message is smaller than or equal to that of lifetime in the PEBU message.

12. The method of claim 9, further comprising:
upon reception of a registration reply (RRep) from the HAv4, sending a Proxy Extension Binding Acknowledgement (PEBack) to the MN, which comprises a registration acknowledgement extension option obtained, according to the PEBack.

13. The method of claim 9, wherein, after the MN returning from the IPv6 network to the IPv4 network, further comprising:
receiving a registration request extension (PERReq) message from the MN, which comprises a binding update extension option whose lifetime value is 0; and
upon reception of the PERReq message, releasing the tunnel between the MN and the FHA, and sending a registration acknowledgement extension (PERRep) message to the MN.

14. The method of claim 11, wherein, when the MN roams from the IPv4 network to the IPv6 network, the method further comprises:
generating a map between the FHoAv6 and the CoA, a map between the HAA and the FHoAv4, and a map between the FHoAv4 and the FHoAv6; and
deleting the map between the FHoAv6 and the CoA and the entry corresponding to the FHA in the map between the FHoAv4 and the FHoAv6, after the MN returning from the IPv6 network to the IPv4 network.

15. The method of claim 13, wherein, when the MN roams from the IPv4 network to the IPv6 network, the method further comprises:
generating a map between the FHoAv6 and the CoA, a map between the HAA and the FHoAv4, and a map between the FHoAv4 and the FHoAv6; and
deleting the map between the FHoAv6 and the CoA and the entry corresponding to the FHA in the map between the FHoAv4 and the FHoAv6, after the MN returning from the IPv6 network to the IPv4 network.

16. The method of claim 9 wherein, when the MN roams from the IPv4 network to the IPv6 network, the method further comprises:
receiving data packets from the MN via the tunnel between the FHA and the MN;
sending the data packets to the HAv4 via the tunnel between the FHA and the HAv4;
receiving data packets from the HAv4 via the tunnel between the FHA and the HAv4; and
sending the data packets to the MN via the tunnel between the FHA and the MN.

17. A system for a mobile node (MN) roaming in an Internet Protocol version 6 (IPv6) network, when the MN roams from an IPv4 network to the IPv6 network, comprising a foreign home agent (FHA) adapted to receive a Binding Update (BU) message from the MN, register a tunnel on an IPv6 network interface between the MN and a Binding Update (BU) message from the MN, wherein the FHA has been assigned both an IPv6 address and an Internet Protocol version 4 (IPv4) address and register a tunnel between the FHA and the IPv4 home agent (HAv4) of the MN on the IPv4 network interface according to the BU message; and
at least one MN, each of the MN adapted to obtain a care of address (CoA) in the IPv6 network and obtain an IPv6 foreign home address (FHoAv6) from the FHA; send the BU message to the FHA, wherein the BU message carries a registration request extension option and the lifetime value in the registration request extension option is smaller than or equal to the lifetime value in the BU, the source address of the BU is the CoA and the destination address is the FHoAv6; and receive a Proxy Extension Binding Acknowledgement (PEBack) message from the FHA, wherein the PEBack carries a registration acknowledgement extension option, the source address of the PEBack is the FHoAv6 and the destination address is the CoA.

18. The system according to claim 17, when the MN roams from an IPv4 network to the IPv6 network, the FHA is further adapted to receive data packets from the MN via the tunnel between the FHA and the MN; send the data packets to the HAv4 via the tunnel between the FHA and the HAv4; receive data packets from the HAv4 via the tunnel between the FHA and the HAv4; and send the data packets to the MN via the tunnel between the FHA and the MN; accordingly,
the MN is further adapted to send the data packets via the tunnel between the FHA and the MN; and receive the data packet from the MN via the tunnel between the FHA and the MN.

19. The system according to claim 17, after the MN returning from the IPv6 network to the IPv4 network, the FHA is further adapted to receive a registration request extension (PERReq) message from the MN, which comprises a binding update extension option whose lifetime value is 0; and upon reception of the PERReq message, releasing the tunnel between the MN and the FHA, and sending a registration acknowledgement extension (PERRep) message to the MN; accordingly,
the MN is further adapted to send the PERReq message to the FHA, and receive the PERRep message from the FHA.
